(19) United States
(12) Patent Application Publication
(10) Pub. No.: US 2026/0268702 A1
(43) Pub. Date: Sep. 10, 2026

(54) IMAGE RECOGNITION METHOD AND DEVICE, STORAGE MEDIUM AND PROGRAM PRODUCT

(71) Applicant: Beijing Zitiao Network Technology Co., Ltd., Beijing (CN)

(72) Inventors: Qingwen HU, Beijing (CN); Dengke DONG, Beijing (CN)

(21) Appl. No.: 19/166,001

(22) PCT Filed: Mar. 14, 2024
(86) PCT No.: PCT/CN2024/081692

§ 371 Date: Sep. 16, 2025

(30) Foreign Application Priority Data
Mar. 24, 2023 (CN) 202310309219.9

(51) Int. Cl. G06V 40/10; G06V 10/44; G06V 10/774

(52) U.S. Cl. CPC G06V 40/10; G06V 10/44; G06V 10/774

(57) ABSTRACT

The embodiments of the present disclosure provide an image recognition method and device, a storage medium and a program product. The method includes: obtaining an image to be processed containing a human body; extracting an image feature from the image to be processed according to an image recognition model, and obtaining a skeleton key point recognition result and a contour key point recognition result according to the image feature; and determining a skeleton key point and a contour key point in the image to be processed respectively according to the skeleton key point recognition result and the contour key point recognition result.

### CROSS-REFERENCE TO RELATED APPLICATIONS

The present application is based on and claims priority to CN patent application No. 202310309219.9 filed on Mar. 24, 2023, the disclosure of which is incorporated by reference herein in its entirety.

### TECHNICAL FIELD

The embodiment of the present disclosure relates to the field of computer and network communication technology, in particular to an image recognition method and device, a storage medium and a program product.

### BACKGROUND

In the tasks of body shaping (body slimming and calf slimming), action understanding and behavior recognition based on human images, it is usually necessary to detect human body key points in an image.

In the related art, human-related key points are mostly detected by Human Pose Estimation. This method usually mainly identifies 17 human body key point positions, such as eyes, nose, ears, shoulders, elbows and wrists. As shown in FIG. 1a, human skeleton is roughly estimated. However, this method which lacks accurate recognition of human edge key points, does not possess the detection technology of human edge contour, so that it is impossible to completely analyze all human parts or favorably support the tasks such as body shaping (body slimming and calf slimming), action understanding and behavior recognition.

### SUMMARY

The embodiment of the present disclosure provides an image recognition method and device, a storage medium and a program product, so as to simultaneously realize the task of recognizing a skeleton key point and a contour key point in an image to be processed containing a human body and completely analyze various human parts.

In a first aspect, the embodiments of the present disclosure provide an image recognition method, including: obtaining an image to be processed containing a human body; inputting the image to be processed into an image recognition model, wherein the image recognition model includes a feature extraction module, a skeleton key point decoding module and a contour key point decoding module; extracting an image feature from the image to be processed by the feature extraction module; obtaining a skeleton key point recognition result by the skeleton key point decoding module according to the image feature; obtaining a contour key point recognition result by the contour key point decoding module according to the image feature and the skeleton key point recognition result; and determining a skeleton key point and a contour key point in the image to be processed respectively according to the skeleton key point recognition result and the contour key point recognition result.

In a second aspect, the embodiments of the present disclosure provide an image recognition apparatus, including: an obtaining unit configured to obtain an image to be processed containing a human body; a processing unit configured to input the image to be processed into an image recognition model, wherein the image recognition model includes a feature extraction module, a skeleton key point decoding module and a contour key point decoding module; extract an image feature from the image to be processed by the feature extraction module; obtain a skeleton key point recognition result by the skeleton key point decoding module according to the image feature; and obtain a contour key point recognition result by the contour key point decoding module according to the image feature and the skeleton key point recognition result; and a key point determining unit configured to determine a skeleton key point and a contour key point in the image to be processed respectively according to the skeleton key point recognition result and the contour key point recognition result.

In a third aspect, the embodiments of the present disclosure provide an electronic device, including: at least one processor and a memory; wherein the memory stores computer-executed instructions; and the at least one processor executes the computer-executed instructions stored in the memory, so that the at least one processor performs the image recognition method as described above in the first aspect and various possible designs of the first aspect.

In a fourth aspect, the embodiments of the present disclosure provide a non-transitory computer-readable storage medium. The computer-readable storage medium has computer-executable instructions stored thereon that, when executed by a processor, implement the image recognition method as described above in the first aspect and various possible designs of the first aspect.

In a fifth aspect, the embodiments of the present disclosure provide a computer program product. The computer program product includes computer-executable instructions that, when executed by a processor, implement the image recognition method as described above in the first aspect and various possible designs of the first aspect.

According to the image recognition method and device, the storage medium and the program product provided by the embodiment of the present disclosure, an image to be processed containing a human body is obtained; the image to be processed is input into an image recognition model, wherein the image recognition model includes a feature extraction module, a skeleton key point decoding module and a contour key point decoding module; an image feature is extracted from the image to be processed by the feature extraction module; a skeleton key point recognition result is obtained by the skeleton key point decoding module according to the image feature; a contour key point recognition result is obtained by the contour key point decoding module according to the image feature and the skeleton key point recognition result; and a skeleton key point and a contour key point in the image to be processed are determined respectively according to the skeleton key point recognition result and the contour key point recognition result.

### BRIEF DESCRIPTION OF THE DRAWINGS

In order to more explicitly explain the technical solutions in the embodiments of the present disclosure or the relevant art, the accompanying drawings required to be used in the description of the embodiments or the relevant art will be briefly introduced below. Obviously, the accompanying drawings described below are some of the embodiments of the present disclosure. For those of ordinary skill in the art, other accompanying drawings may also be obtained according to these accompanying drawings on the premise that no inventive effort is involved.

FIG. 1a is an example diagram of human body skeleton key points;

FIG. 1b is an example diagram of human body contour key points provided by embodiments of the present disclosure;

FIG. 2 is a flow chart of an image recognition method provided by embodiments of the present disclosure;

FIG. 3 is a structural diagram of an image recognition model provided by embodiments of the present disclosure;

FIG. 4 is a flow chart of a training method of an image recognition model provided by embodiments of the present disclosure;

FIG. 5 is a schematic view of loss composition provided by embodiments of the present disclosure;

FIG. 6 is a structural block diagram of an image recognition apparatus provided by one embodiment of the present disclosure;

FIG. 7 is a structural block diagram of an image recognition apparatus provided by another embodiment of the present disclosure;

FIG. 8 is a schematic view of a hardware structure of an electronic device provided by embodiments of the present disclosure.

### DETAILED DESCRIPTION

In order to make the objects, technical solutions and advantages of the embodiments of the present disclosure more explicit, the technical solution in the embodiment of the present disclosure will be explicitly and fully described below in conjunction with the accompanying drawings in the embodiment of the present disclosure. Apparently, the embodiments described are some embodiments of the present disclosure, rather than all of the embodiments. On the basis of the embodiments of the present disclosure, all the other embodiments obtained by those of ordinary skill in the art on the premise that no inventive effort is involved shall fall into the protection scope of the present disclosure.

In the tasks of body shaping (body slimming and calf slimming), action understanding and behavior recognition based on human images, it is usually necessary to detect human body key points in an image.

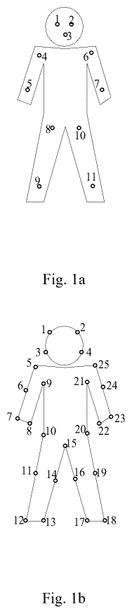

In the related art, human-related key points are mostly detected by Human Pose Estimation. This method usually mainly identifies positions of human body key points (skeleton key points) such as eyes, nose, ears, shoulders, elbows and wrists. For the skeleton key points in a schematic view as shown in FIG. 1a, human skeleton is roughly estimated. However, this method which lacks accurate recognition of edge key points of human body, does not possess the detection technology for the human body edge contour, so that it is impossible to completely analyze all human parts or favorably support the tasks such as body shaping (body slimming and calf slimming), action understanding and behavior recognition.

In order to support the tasks such as body shaping (body slimming and calf slimming), action understanding and behavior recognition, it is also necessary to detect an edge contour of a human body in a human body image, for example, an edge point in a schematic view shown in FIG. 1b. In the related art, for detection of the edge contour of a human body, the contour of a human body is mostly obtained by extracting a feature of relevant edge information by using a traditional image processing method. Therefore, in order to recognize a skeleton key point and an edge contour, it is necessary to perform a skeleton key point detection method (such as the above-described Human Posture Estimation) and an edge contour detection method respectively, and it takes a long time to perform two tasks serially, which results in that the downstream tasks such as body shaping (body slimming and calf slimming), action understanding and behavior recognition cannot achieve a real-time result. In addition, edge contour detection lacks semantic information about a human body edge, for example, it is only possible to determine a human body edge position, but it is impossible to determine where a palm edge is or where a leg edge is.

In order to shorten the time consumption and improve the processing efficiency, the present disclosure considers simultaneously recognizing a skeleton key point and a contour key point for an image to be processed containing a human body. Therefore, the present disclosure provides an image recognition method, wherein an image to be processed containing a human body is obtained; the image to be processed is input into an image recognition model, wherein the image recognition model includes a shared encoder, a skeleton key point decoding module and a contour key point decoding module; extracting an image feature from the image to be processed by the feature extraction module; a skeleton key point recognition result is obtained by the skeleton key point decoding module according to the image feature; a contour key point recognition result is obtained by the contour key point decoding module according to the image feature and the skeleton key point recognition result; and a skeleton key point and a contour key point in the image to be processed are determined respectively according to the skeleton key point recognition result and the contour key point recognition result. In this embodiment, the image recognition model may simultaneously realize the tasks of recognizing a skeleton key point and a contour key point in an image to be processed containing a human body and completely analyze various parts of the human body to shorten the time consumption and improve the processing efficiency, which provides a stable technical support for subsequent body shaping, action understanding, behavior recognition and the like.

In the present application, according to the research and statistics of the human contour, the human contour may be formed by connecting a plurality of contour key points. As shown in FIG. 1b, for example, 1-4 are the head contour key points and 5-8 are the arm contour key points. These key points are connected sequentially to constitute a general contour of the human body edge, with abundant semantic information.

One application scenario of the image recognition method of the present disclosure is applied in a terminal device or a server.

Alternatively, if the image recognition method is applied to a terminal device (for example, a cell phone, a tablet computer and the like), it is possible to acquire the image to be processed containing a human body by a camera, or receive the image to be processed containing a human body transmitted by other devices, or read the image to be processed containing a human body stored in a storage unit, and then perform the image recognition method of the present disclosure.

Alternatively, if the image recognition method is applied to the server, it is possible to obtain the image to be processed containing a human body by the terminal device and upload the same to the server, and perform the image recognition method of the present disclosure by the server, and then send the determined skeleton key point and contour key point to the terminal device.

It may be understood that, before the technical solution disclosed in each embodiment of the present disclosure is used, the user shall be informed of the type, application range and application scene of personal information involved in the present application in an appropriate manner according to the relevant laws and regulations, and user authorization will be obtained.

For example, in response to receiving an active request of the user, prompt information is sent to the user to explicitly prompt the user that the operation requested to be performed by the user will require obtaining and using personal information of the user. Therefore, the user may independently choose whether to provide personal information to software or hardware such as electronic devices, applications, servers or storage media that perform the operation of the technical solution of the present disclosure according to the prompt information.

As an optional but non-limiting implementation, in response to receiving an active request of the user, the method of sending the prompt information to the user may be, for example, a pop-up window, in which the prompt information may be presented in text. In addition, the pop-up window may also carry a selection control for the user to choose to “agree” or “disagree” to provide personal information to the electronic device.

It may be understood that, the above-described process of notifying and obtaining user authorization which is only schematic, does not constitute a delimitation on the implementation of the present disclosure, and other methods which comply with the relevant laws and regulations may also be applied to the implementation of the present disclosure.

The image recognition method of the present disclosure will be introduced below in detail in conjunction with specific embodiments.

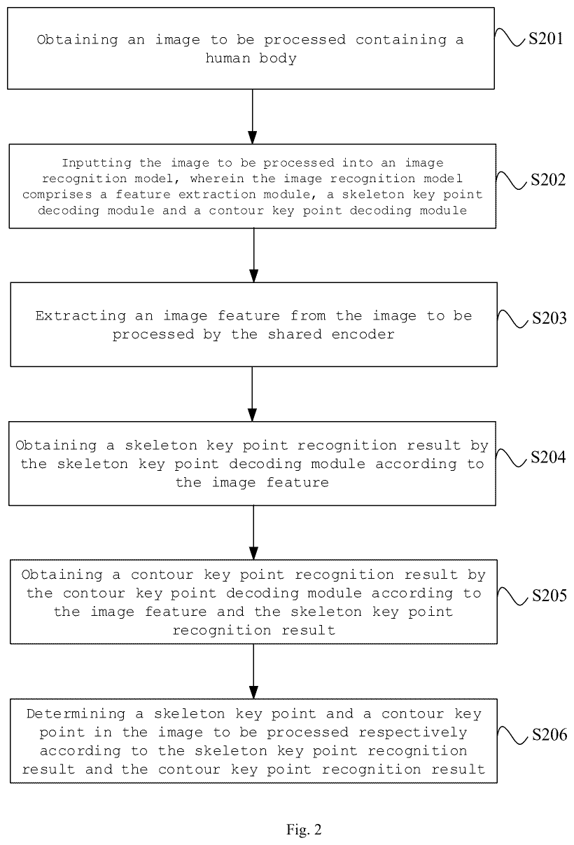

Referring to FIG. 2, FIG. 2 is a flow chart of an image recognition method provided by one embodiment of the present disclosure. The method of this embodiment may be applied to a terminal device or a server, and the image recognition method includes:

In S201, an image to be processed containing a human body is obtained.

In this embodiment, it is possible to acquire the image to be processed containing a human body by an image acquisition device, or receive the image to be processed containing a human body transmitted by other devices, or read the image to be processed containing a human body stored in a storage unit, or obtain an image to be processed containing a human body by other methods, which will not be described in detail here.

In S202, the image to be processed is input into an image recognition model, wherein the image recognition model includes a feature extraction module, a skeleton key point decoding module and a contour key point decoding module.

In this embodiment, in order to avoid that two separate recognition models in series are required to recognize a skeleton key point and a contour key point in the image to be processed so that it is time-assuming and slow in processing, one image recognition model may be constructed and trained so that the task of recognizing a skeleton key point and task of recognizing a contour key point may be realized simultaneously in one model. Alternatively, the joint model may be a convolutional neural network model.

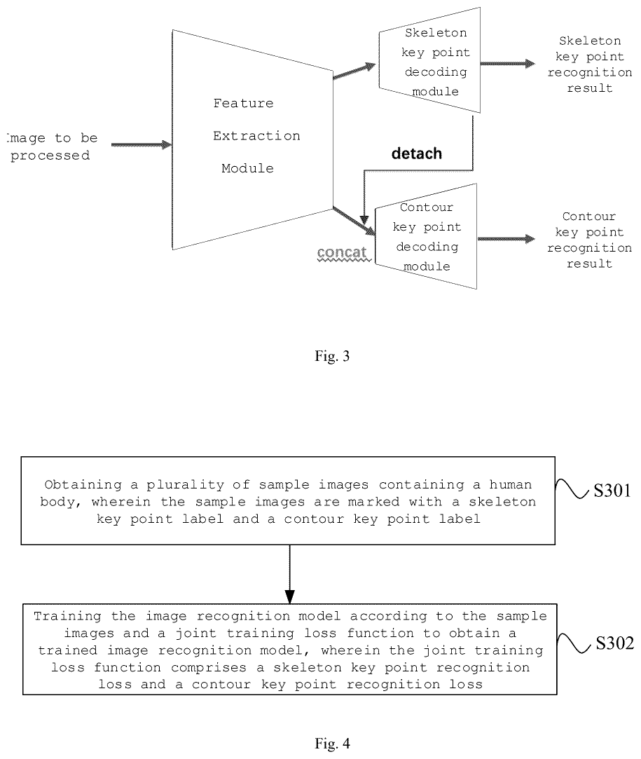

Alternatively, as shown in FIG. 3, the joint model includes a feature extraction module (“shared encoder”), a skeleton key point decoding module (“skeleton decoder”) and a contour key point decoding module (“contour decoder”), wherein the feature extraction module is a backbone of the model, which may be used to extract an image feature from the image to be processed; and the skeleton key point decoding module and the contour key point decoding module are recognition modules for realizing the task of recognizing a skeleton key point and the task of recognizing a contour key point respectively, also that is, dual-branch recognition modules are connected by a backbone network. More specifically, the skeleton key point decoding module may output a skeleton key point recognition result. Alternatively, the skeleton key point recognition result may be a skeleton key point heatmap, and the contour key point decoding module may output a contour key point recognition result. Alternatively, the contour key point recognition result may be a contour key point heatmap, and the skeleton key point decoding module and the contour key point decoding module may use a network structure capable of realizing a key point heatmap method.

In this embodiment, after obtaining the image to be processed containing a human body, it is possible to input the image to be processed into the image recognition model, process the image to be processed by the joint model, and output the skeleton key point recognition result and the contour key point recognition result.

In S203, an image feature is extracted from the image to be processed by the feature extraction module.

In this embodiment, after the image to be processed is input into the image recognition model, an image feature may be extracted from the image to be processed by the feature extraction module.

In S204, the skeleton key point recognition result is obtained by the skeleton key point decoding module according to the image feature.

In this embodiment, the image feature is input to the skeleton key point decoding module, and the skeleton key point recognition result is obtained by the skeleton key point decoding module according to the image feature. Alternatively, the skeleton key point heatmap may be obtained by the skeleton key point decoding module according to the image feature, and the skeleton key point heatmap may be determined as the skeleton key point recognition result.

In S205, the contour key point recognition result is obtained by the contour key point decoding module according to the image feature and the skeleton key point recognition result.

In this embodiment, considering that the skeleton key point has more abundant semantic information than the contour key point, and the learning is relatively less difficult, with a close perceptual correlation with the human body contour key point, after obtaining the skeleton key point recognition result according to the image feature, the contour key point decoding module may be guided to learn the contour feature jointly according to the image feature and the skeleton key point recognition result. Also, that is, the contour key point recognition result may be obtained according to the image feature and the skeleton key point recognition result. In this way, the contour key point also possesses abundant semantic information, for example, accurately knowing the contours of the left and right hands, the position of the abdominal edge, the position of the leg edge and the like, and providing basic ability for subsequent technologies such as automatic body shaping (body slimming and calf slimming). Specifically, the image feature may be fused with the skeleton key point recognition result by the contour key point decoding module, so as to obtain the contour key point recognition result according to the fusion result. Wherein, in order to improve the effect simply and effectively, the feature fusion here uses a simple concat manner, so that the image feature and the image feature related to the skeleton key point recognition result (obtained by a detach operation on the skeleton key point recognition result) may be concated.

In S206, a skeleton key point and a contour key point are determined in the image to be processed respectively according to the skeleton key point recognition result and the contour key point recognition result.

In this embodiment, after the skeleton key point recognition result and the contour key point recognition result are obtained, the coordinates of the skeleton key points and contour key points may be determined based on the skeleton key point recognition result and the contour key point recognition result. Specifically, the coordinates of the skeleton key points may be determined according to the skeleton key point heatmap, and the coordinates of the contour key points may be determined according to the contour key point heatmap, so that the skeleton key points and the contour key points in the image to be processed are obtained.

In the image recognition method provided by this embodiment, the storage medium and the program product provided by the embodiment of the present disclosure, an image to be processed containing a human body is obtained; the image to be processed is input into an image recognition model, wherein the image recognition model includes a feature extraction module, a skeleton key point decoding module and a contour key point decoding module; an image feature is extracted from the image to be processed by the feature extraction module; and a skeleton key point and a contour key point in the image to be processed are determined respectively according to the skeleton key point recognition result and the contour key point recognition result. In this embodiment, the image recognition model may simultaneously realize the task of recognizing a skeleton key point and a contour key point in an image to be processed containing a human body and completely analyze various parts of the human body to shorten the time consumption and improve the processing efficiency, which provides a stable technical support for subsequent body shaping, action understanding, behavior recognition and the like.

Referring to FIG. 4, FIG. 4 is a flow chart of a training method of an image recognition model provided by one embodiment of the present disclosure. The method of this embodiment may be applied to a terminal device or a server, which may be a terminal device or server performing the above-described image recognition method, and of course may also be other terminal devices or servers. In order to train the image recognition model in the above-described embodiment, the training method of an image recognition model includes:

In S301, a plurality of sample images containing a human body are obtained, wherein the sample images are marked with a skeleton key point label and a contour key point label.

In this embodiment, since the image recognition model in the above-described embodiment may address the tasks of recognizing a skeleton key point and a contour key point at the same time, the sample images containing a human body for training the joint model are also required to be marked with a skeleton key point label and a contour key point label at the same time. In this embodiment, the method of obtaining the sample images is not limited, and the marking method is not limited as well, for example, it may be manual marking.

Alternatively, the embodiment form of the label may be determined according to the output type of the image recognition model. For example, when the predicted skeleton key point recognition result output by the image recognition model is the predicted skeleton key point heatmap and the predicted contour key point recognition result is the predicted contour key point heatmap, the skeleton key point label marked by the sample images is represented by the sample skeleton key point heatmap, and the contour key point label is represented by the sample contour key point heatmap. Therefore, when a plurality of sample images containing a human body are obtained, corresponding sample skeleton key point heatmap and sample contour key point heatmap may be obtained as labels according to any sample image, so that the sample images, and the corresponding sample skeleton key point heatmap and sample contour key point heatmap serve as a set of training data.

In this embodiment, since the image recognition model actually outputs the skeleton key point heatmap and the contour key point heatmap, it is necessary to obtain corresponding skeleton key point heatmap and contour key point heatmap according to the sample images, convert each skeleton key point position into a sample skeleton key point heatmap according to the skeleton key point label, and convert each contour key point position into a sample contour key point heatmap according to the contour key point label. Furthermore, the sample images and the corresponding sample skeleton key point heatmap and sample contour key point heatmap serve as a set of training data, wherein the sample images serve as the input of the model, and the sample skeleton key point heatmap and the sample contour key point heatmap serve as the groundtruth, so that a training data set may be obtained.

In S302, the image recognition model is trained according to the sample images and a joint training loss function to obtain a trained image recognition model, wherein the joint training loss function includes a skeleton key point recognition loss and a contour key point recognition loss.

In this embodiment, the image recognition model is trained based on the training data. Since the image recognition model may address the tasks of recognizing a skeleton key point and a contour key point at the same time, it is equivalent to joint training of two tasks, and each recognition task is present with certain loss. Therefore, the loss function during the training process is required to combine the losses of two tasks. Also that is, the joint training loss function is obtained based on the skeleton key point recognition loss and the contour key point recognition loss, and the image recognition model is adjusted according to the joint training loss function.

Specifically, when the joint model is trained according to the training data, the joint model obtains the predicted skeleton key point recognition result and the predicted contour key point recognition result according to the sample images, obtains the skeleton key point recognition loss Lₛₖₑₗₑₜₒₙ based on the predicted skeleton key point recognition result and the skeleton key point label corresponding to the sample images (for example, the groundtruth of the sample skeleton key points); obtains the contour key point recognition loss L_{contour} based on the predicted contour key point recognition result and the contour key point label corresponding to the sample images (for example, the groundtruth of the sample contour key points); and performs weighted summation on the skeleton key point recognition loss Lₛₖₑₗₑₜₒₙ and the contour key point recognition loss L_{contour} to obtain the joint training loss function L. The calculation formula is as follows:

$$L = a * {L}_{contour} + {L}_{skeleton}$$

Where, a represents that the weight of the contour key point recognition loss L_{contour} is a times that of the skeleton key point recognition loss Lₛₖₑₗₑₜₒₙ, and a may be set according to actual conditions.

In the training method of an image recognition model in this embodiment, joint training may allow the joint model to achieve a favorable recognition effect on the tasks of recognizing a skeleton key point and a contour key point, and joint training has a higher efficiency and a lower cost compared with training two recognition models separately, and a recognition effect that is not lower than two separate recognition models.

On the basis of any of the above-described embodiments, the skeleton key point label and the contour key point label marked by the sample images may all be manually marked. Also that is, the skeleton key point label and the contour key point label are real labels, but a high labor cost is consumed. Of course, automatic labeling may also be performed by a specific algorithm. In particular, it is possible that some sample images are only marked with skeleton key point labels, and some sample images are only marked with contour key point labels. In this case, the step of obtaining the sample images marked with a skeleton key point and a contour key point at the same time may specifically include that:

A plurality of first sample images and a plurality of second sample images are obtained, wherein the first sample images are marked with a skeleton key point label and the second sample images are marked with a contour key point label.

The skeleton key point recognition model is trained according to the first sample images, the skeleton key point in the second sample images is recognized according to the skeleton key point recognition model, and a skeleton key point pseudo-label is added to the recognized skeleton key point, wherein the skeleton key point recognition model is a single model for recognizing a skeleton key point, and wherein the skeleton key point recognition model may be a large model. Since the first sample images are marked with a skeleton key point label accurately, and the trained skeleton key point recognition model is a large model which itself has a strong learning ability, accurate recognition may be achieved when there are limited labels, so that the second sample images may be automatically marked with a skeleton key point pseudo-label.

The contour key point recognition model is trained according to the second sample images, the contour key point in the second sample images is recognized according to the contour key point recognition model, and a contour key point pseudo-label is added to the recognized contour, wherein the contour key point recognition model is a single model for recognizing a contour key point, and wherein the contour key point recognition model may be a large model. Since the second sample images is marked with a contour key point label accurately, and the trained contour key point recognition model is a large model which itself has a strong learning ability, accurate recognition may be achieved when there are limited labels, so that the first sample images may be automatically marked with a contour key point pseudo-label.

In this embodiment, the method of making a pseudo-label may allow that all the sample images are marked with a skeleton key point label and a contour key point label, which solves the circumstance that some sample images only have a certain label and ensures the amount of the training data.

On the basis of the above-described embodiments, although the first sample images and the second sample images are both marked with a skeleton key point label and a contour key point label, the pseudo-label is, after all, marked by the model so that it is possible to be inaccurate. Therefore, when the weights of the skeleton key point recognition loss and the contour key point recognition loss in the joint training loss function are set, it is necessary to consider the number of the first sample images and the second sample images to avoid the imbalance problem of the model. Wherein, if the first sample images are more than the second sample images, the weight of the skeleton key point recognition loss is less than that of the contour key point recognition loss. If the first sample images are less than the second sample images, the weight of the skeleton key point recognition loss is greater than that of the contour key point recognition loss.

For example, in general, the skeleton key point is more easily marked than the contour key point, so that the first sample images are far more than the second sample images (possibly more than 10 times). In order to avoid that the model is prone to the task of recognizing the skeleton key point during joint training, which results in that the task of recognizing the skeleton key point is more accurate. Moreover, since the task of recognizing the contour key point is inaccurate, the weight of the skeleton key point recognition loss may be set to be less than that of the contour key point recognition loss. For example, in the above-described embodiment, the calculation formula L=a*L_{contour}+Lₛₖₑₗₑₜₒₙ, and a may be taken as 3. Also that is, the weight of the contour key point recognition loss L_{contour} is three times that of the skeleton key point recognition loss Lₛₖₑₗₑₜₒₙ, so that the model training process is more balanced and the task of recognizing the skeleton key point and the task of recognizing the contour key point may be accurate.

On the basis of the above-described embodiment, it is also considered that the pseudo-labels in the first sample images and the second sample images might be inaccurate, so that it is necessary to attenuate the loss related to the pseudo-label so as to reduce the influence of the pseudo-label on joint training, which is specifically as follows:

If the sample images for training are the first sample images added with a contour key point pseudo-label, also that is, a corresponding skeleton key point label is accurate and the accuracy of the contour key point label is uncertain, the skeleton key point recognition loss is accurate and the accuracy of the contour key point recognition loss is uncertain, so that the weight of the contour key point recognition loss may be attenuated, for example, by 0.5 times.

If the sample images for training are the second sample images added with a skeleton key point pseudo-label, also that is, a corresponding skeleton key point label is accurate and the accuracy of the skeleton key point label is uncertain, the skeleton key point recognition loss is accurate and the accuracy of the skeleton key point recognition loss is uncertain, so that the weight of the skeleton key point recognition loss may be attenuated, for example, by 0.5 times.

Of course, if the skeleton key point label and the contour key point label in the sample images are both real labels (manual marking or manual confirmation), the weight of the skeleton key point recognition loss and weight of the contour key point recognition loss are not required be attenuated.

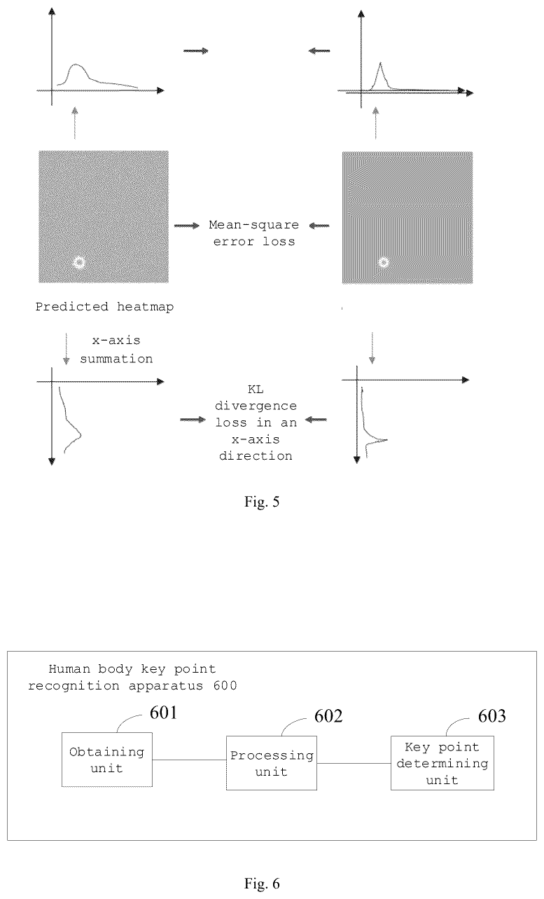

On the basis of any of the above-described embodiments, in order to improve the effect of recognizing a skeleton key point and a contour key point, a current dominant method is to use MSE (Mean-Square Error) Loss. However, the heatmap learned by MSE Loss only fits the distribution of a real heatmap as much as possible, but does not favorably constrain the distribution of the heatmap, which results in that the heatmap is prone to misjudgment or multiple peaks. In order to solve this problem, this embodiment provides a KL (Kullback-Leibler) divergence loss (KL Divergence Loss) to predict the distribution of the heatmap of each key point. Specifically as shown in FIG. 5: the predicted heatmap and the sample groundtruth of the human body key points (including a skeleton key point and/or a contour key point) are summed in one-dimensional direction (x and y axis directions) respectively, and then the KL divergence loss is used to measure a difference between the predicted distribution and the real distribution. As shown in FIG. 5, the two-dimensional heatmap is disassembled into one dimension to constrain the distribution of the heatmap and reduce the difficulty of fitting the distribution, which may simply and effectively improve the fitting effect of the model on the heatmap and improve the recognition effect of the key point. Finally, the loss of each human body key point (including a skeleton key point and/or a contour key point) is a weighted sum of a mean-square error loss and a KL divergence loss, and the calculation formula is as follows:

$${L}_{key point} = α * {L}_{MSB} + β * {KL\_loss}_{x} + γ * {KL\_loss}_{y}$$

Where, LMSE represents a mean-square error loss; KL_loss, represents a KL divergence loss in the x-axis direction; KL_loss_{y} represents a KL divergence loss in the y-axis direction; α, β and γ represent weights respectively, and alternatively, are 1.0, 0.1, and 0.1 respectively in this embodiment.

Taking the skeleton key point recognition loss as an example for description below, the mean-square error loss between the predicted skeleton key point heatmap and the sample skeleton key point heatmap is obtained; KL divergence loss in a one-dimensional direction is obtained according to the coordinate sum of each skeleton key point of the predicted skeleton key point heatmap in a one-dimensional direction and the coordinate sum of each skeleton key point of the sample skeleton key point heatmap in a one-dimensional direction, wherein a one-dimensional direction includes an X-axis direction and a Y-axis direction; and weighted summation is performed on the mean-square error loss and the KL divergence loss in one dimension to obtain a skeleton key point recognition loss.

Taking the skeleton key point recognition loss as an example for description, the mean-square error loss between the predicted contour key point heatmap and the sample contour key point heatmap is obtained; KL divergence loss in a one-dimensional direction is obtained according to the coordinate sum of each contour key point of the predicted contour key point heatmap in a one-dimensional direction and the coordinate sum of each contour key point of the sample contour key point heatmap in a one-dimensional direction, wherein a one-dimensional direction includes an X-axis direction and a Y-axis direction; and weighted summation is performed on the mean-square error loss and the KL divergence loss in one dimension to obtain a contour key point recognition loss.

The distribution of the heatmap is constrained so that the joint model may favorably constrain the skeleton key point heatmap and the contour key point heatmap, and the skeleton key point heatmap and the contour key point heatmap may be approximate to the real distribution as much as possible.

Corresponding to the image recognition method of the above embodiment, FIG. 6 is a structural block diagram of an image recognition apparatus provided by an embodiment of the present disclosure. For ease of description, only parts related to the embodiment of the present disclosure are shown. Referring to FIG. 6, the image recognition apparatus 600 includes: an obtaining unit 601, a processing unit 602 and a key point determining unit 603.

Wherein, the obtaining unit 601 is configured to obtain an image to be processed containing a human body;

The processing unit 602 is configured to input the image to be processed into an image recognition model, wherein the image recognition model includes a feature extraction module, a skeleton key point decoding module and a contour key point decoding module; extract an image feature from the image to be processed by the feature extraction module; obtain a skeleton key point recognition result by the skeleton key point decoding module according to the image feature; and obtain a contour key point recognition result by the contour key point decoding module according to the image feature and the skeleton key point recognition result;

The key point determining unit 603 is configured to determine a skeleton key point and a contour key point in the image to be processed respectively according to the skeleton key point recognition result and the contour key point recognition result.

In one or more embodiments of the present disclosure, when the skeleton key point decoding module obtains a skeleton key point recognition result according to the image feature, the processing unit 602 is configured to: obtain a skeleton key point heatmap by the skeleton key point decoding module according to the image feature, and determine the skeleton key point heatmap as the skeleton key point recognition result; obtain a contour key point recognition result by the contour key point decoding module according to the image feature and the skeleton key point recognition result, including: fusing the image feature and the skeleton key point heatmap by the contour key point decoding module, obtaining the contour key point heatmap according to the fusion result, and determining the contour key point heatmap as the skeleton key point recognition result.

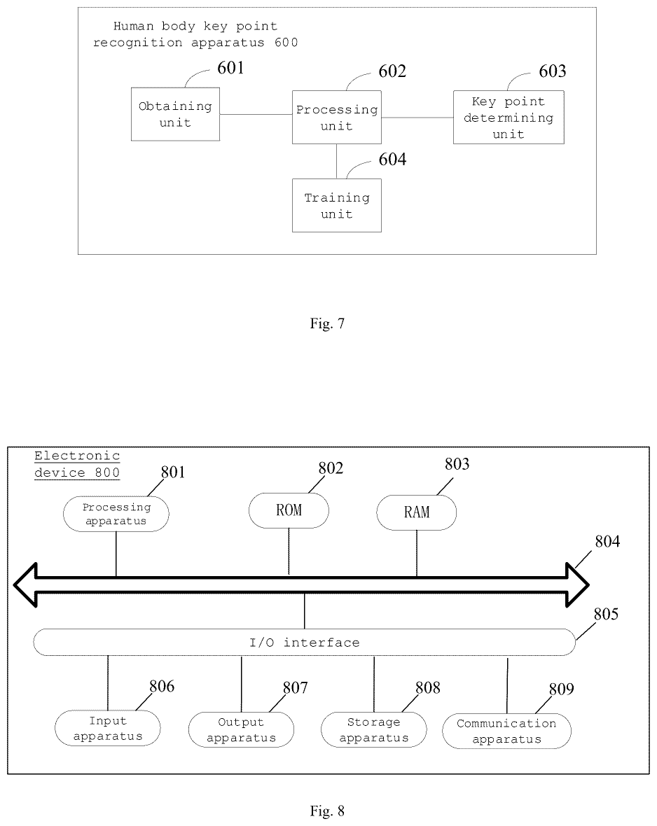

In one or more embodiments of the present disclosure, as shown in FIG. 7, the image recognition apparatus 600 further includes a training unit 604 configured to: obtain a plurality of sample images containing a human body, wherein the sample images are marked with a skeleton key point label and a contour key point label; and train an image recognition model according to the sample images and a joint training loss function to obtain a trained image recognition model, wherein the joint training loss function includes a skeleton key point recognition loss and a contour key point recognition loss.

In one or more embodiments of the present disclosure, when a plurality of sample images containing a human body are obtained, the training unit 604 is configured to: obtain a plurality of first sample images and a plurality of second sample images, wherein the first sample images are marked with a skeleton key point label, and the second sample images are marked with a contour key point label; train a skeleton key point recognition model according to the first sample images, recognize a skeleton key point in the second sample images according to the skeleton key point recognition model, and add a skeleton key point pseudo-label to a recognized skeleton key point; train a contour key point recognition model according to the second sample images, recognize a contour key point in the first sample images according to the contour key point recognition model, and add a contour key point pseudo-label to a recognized contour key point.

In one or more embodiments of the present disclosure, when the image recognition model is trained according to the sample images and a joint training loss function, the training unit 604 is further configured to: obtain the skeleton key point recognition loss based on the predicted skeleton key point recognition result obtained by the joint model according to the sample images and the skeleton key point label corresponding to the sample images; obtain the contour key point recognition loss based on the predicted contour key point recognition result obtained by the joint model according to the sample images and the contour key point label corresponding to the sample images; and perform weighted summation on the skeleton key point recognition loss and the contour key point recognition loss to obtain the joint training loss function.

In one or more embodiments of the present disclosure, the training unit 604 is further configured to: determine the weights of the skeleton key point recognition loss and the contour key point recognition loss in the joint training loss function according to the numbers of the first sample images and the second sample images; wherein, in response that the first sample images are more than the second sample images, the weight of the skeleton key point recognition loss is less than that of the contour key point recognition loss; and in response that the first sample images are less than the second sample image, the weight of the skeleton key point recognition loss is greater than the weight of the contour key point recognition loss.

In one or more embodiments of the present disclosure, the training unit 604 is further configured to: attenuate the weight of the contour key point recognition loss in response that the sample images are the first sample images added with the contour key point pseudo-label; or attenuate the weight of the skeleton key point recognition loss in response that the sample images are the second sample images added with the skeleton key point pseudo-label.

In one or more embodiments of the present disclosure, the skeleton key point label marked in the sample images is represented by a sample skeleton key point heatmap, and the contour key point label is represented by a sample contour key point heatmap.

The predicted skeleton key point recognition result is a predicted skeleton key point heatmap; and the predicted contour key point recognition result is a predicated contour key point heatmap.

In one or more embodiments of the present disclosure, the training unit 604 is further configured to: obtain a mean-square error loss between the predicted human body key point heatmap and the sample human body key point heatmap; wherein the human body key points include at least one of the skeleton key point or the contour key point; obtain a KL divergence loss in one dimension accord to a coordinate sum of each human body key point in the predicted human body key point heatmap and a coordinate sum of each human body key point in the sample human body key point heatmap; wherein the one-dimensional direction includes an x-axis direction and a y-axis direction; and perform weighted summation on the mean-square error loss and the KL divergence loss in one dimension to obtain a human body key point recognition loss.

The image recognition apparatus provided by the present embodiment may be used to perform the technical solution of the above-described image recognition method embodiment, with similar implementation principles and technical effects, which will not be described in detail here.

Referring to FIG. 8, which shows a structural schematic view of an electronic device 800 suitable for implementing the embodiment of the present disclosure, the electronic device 800 may be a terminal device or a server. Wherein, the terminal device may include, but is not limited to, a mobile terminal such as a cell phone, a notebook computer, a digital broadcast receiver, a Personal Digital Assistant (referred to as PDA for short), a Portable Android Device (referred to as PAD for short), a Portable Multimedia Player (referred to as PMP for short) and a vehicle-mounted terminal (for example, a vehicle-mounted navigation terminal); and a fixed terminal such as a digital TV and a desktop computer. The electronic device shown in FIG. 8 which is only an example, shall not limit the functions and application range of the embodiments of the present disclosure.

As shown in FIG. 8, the electronic device 800 may include a processing apparatus (for example, a central processing unit, a graphic processor, and the like) 801, which may perform various appropriate actions and processing according to a program stored in a Read-only Memory (referred to as ROM for short) 802 or a program loaded from a storage apparatus 808 into a Random Access Memory (referred to as RAM for short) 803. In the RAM 803, various programs and data required for the operation of the electronic device 800 are also stored. The processing apparatus 801, the ROM 802 and the RAM 803 are connected to each other through a bus 804. The input/output (I/O) interface 805 is also connected to the bus 804.

Generally, the following apparatuses may be connected to the I/O interface 905: an input apparatus 806 including, for example, a touch screen, a touch pad, a keyboard, a mouse, a camera, a microphone, an accelerometer, a gyroscope, and the like; an output apparatus 807 including, for example, a Liquid Crystal Display (referred to as LCD for short), a speaker, a vibrator, and the like; a storage apparatus 808 including, for example, a magnetic tape, a hard disk, and the like; and a communication apparatus 809. The communication apparatus 809 may allow the electronic device 800 to be in wireless or wired communication with other devices to exchange data. Although FIG. 8 shows the electronic device 800 with various apparatuses, it should be understood that it is not required to implement or possess all the apparatuses shown. It is possible to alternatively implement or possess more or less apparatuses.

In particular, according to the embodiment of the present disclosure, the process described above with reference to the flow chart may be implemented as a computer software program. For example, the embodiment of the present disclosure includes a computer program product including a computer program carried on a computer-readable medium, wherein the computer program contains program codes for performing the method shown in the flow chart. In such embodiment, the computer program may be downloaded and installed from the network through the communication apparatus 809, installed from the storage apparatus 808, or installed from the ROM 802. When the computer program is executed by the processing apparatus 801, the above-described functions defined in the method according to any of the embodiments of the present disclosure are performed.

It is to be noted that, the above-described computer-readable medium of the present disclosure may be a computer-readable signal medium, a computer-readable storage medium or any combination thereof. The computer-readable storage medium may be, for example, but is not limited to: an electrical, magnetic, optical, electromagnetic, infrared, or semiconductor system, apparatus, or device, or a combination thereof. More specific examples of the computer-readable storage medium may include, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program which may be used by an instruction execution system, apparatus, or device or used in combination therewith. In the present disclosure, the computer-readable signal medium may include a data signal propagated in a baseband or as a part of a carrier wave, wherein a computer-readable program code is carried. Such propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by an instruction execution system, apparatus, or device or in combination with therewith. The program code contained on the computer-readable medium may be transmitted by any suitable medium, including but not limited to: a wire, an optical cable, radio frequency (RF), and the like, or any suitable combination thereof.

The above-described computer-readable medium may be included in the above-described electronic device; or may also exist alone without being assembled into the electronic device.

The above-described computer-readable medium carries one or more programs, that, when executed by the electronic device, cause the electronic device to: perform the method shown in any of the above-described embodiments.

The computer program code for performing the operations of the present disclosure may be written in one or more programming languages or a combination thereof. The above-described programming languages include object-oriented programming languages, such as Java, Smalltalk, and C++, and also include conventional procedural programming languages, such as “C” language or similar programming languages. The program code may be executed entirely on the user's computer, partly on the user's computer, executed as an independent software package, partly on the user's computer and partly executed on a remote computer, or entirely executed on the remote computer or server. In the case of a remote computer, the remote computer may be connected to the user's computer through any kind of network (including a local area network (referred to as LAN for short) or a wide area network (referred to as WAN for short)), or may be connected to an external computer (for example, connected through Internet using an Internet service provider).

The flow charts and block views in the accompanying drawings illustrate the possibly implemented architectures, functions, and operations of the system, method, and computer program product according to various embodiments of the present disclosure. In this regard, each block in the flow chart or block view may represent a module, a program segment, or a part of code, wherein the module, the program segment, or the part of code contains one or more executable instructions for realizing a specified logic function. It should also be noted that, in some alternative implementations, the functions marked in the block may also occur in a different order from the order marked in the accompanying drawings. For example, two blocks shown in succession which may actually be executed substantially in parallel, may sometimes also be executed in a reverse order, depending on the functions involved. It is also to be noted that each block in the block view and/or flow chart, and a combination of the blocks in the block view and/or flow chart, may be implemented by a dedicated hardware-based system that performs the specified functions or operations, or may be implemented by a combination of dedicated hardware and computer instructions.

The units involved in the described embodiments of the present disclosure may be implemented in software or hardware. Wherein, the name of the unit does not constitute a delimitation on the unit itself in a certain circumstance. For example, the first obtaining unit may also be described as “a unit of obtaining at least two internet protocol addresses”.

The functions described hereinabove may be performed at least in part by one or more hardware logic components. For example, without limitation, the hardware logic components of a demonstrative type that may be used include: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

In the context of the present disclosure, a machine-readable medium may be a tangible medium, which may contain or store a program for use by the instruction execution system, apparatus, or device or use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, device or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

It is to be noted that, the user information (including but not limited to human body images and the like) and data (including but not limited to data for analysis, stored data, displayed data and the like) involved in the present application are all information and data authorized by users or adequately authorized by all parties, and the collection, use and processing of relevant data need to comply with relevant laws, regulations and standards of relevant countries and regions, and corresponding operation accesses are provided for users to choose authorization or refusal.

In a first aspect, according to one or more embodiments of the present disclosure, an image recognition method is provided. The method includes: obtaining an image to be processed containing a human body; inputting the image to be processed into an image recognition model, wherein the image recognition model includes a feature extraction module, a skeleton key point decoding module and a contour key point decoding module; extracting an image feature from the image to be processed by the feature extraction module; obtaining a skeleton key point recognition result by the skeleton key point decoding module according to the image feature; obtaining a contour key point recognition result by the contour key point decoding module according to the image feature and the skeleton key point recognition result; and determining a skeleton key point and a contour key point in the image to be processed respectively according to the skeleton key point recognition result and the contour key point recognition result.

According to one or more embodiments of the present disclosure, obtaining a skeleton key point recognition result by the skeleton key point decoding module according to the image feature includes: obtaining a skeleton key point heatmap by the skeleton key point decoding module according to the image feature, and determining the skeleton key point heatmap as the skeleton key point recognition result; and obtaining a contour key point recognition result by the contour key point decoding module according to the image feature and the skeleton key point recognition result, including: fusing the image feature and the skeleton key point heatmap by the contour key point decoding module, obtaining the contour key point heatmap according to the fusion result, and determining the contour key point heatmap as the skeleton key point recognition result.

According to one or more embodiments of the present disclosure, the training process of the image recognition model includes: obtaining a plurality of sample images containing a human body, wherein the sample images are marked with a skeleton key point label and a contour key point label; and training an image recognition model according to the sample images and a joint training loss function to obtain a trained image recognition model, wherein the joint training loss function includes a skeleton key point recognition loss and a contour key point recognition loss.

According to one or more embodiments of the present disclosure, obtaining a plurality of sample images containing a human body includes: obtaining a plurality of first sample images and a plurality of second sample images, wherein the first sample images are marked with a skeleton key point label, and the second sample images are marked with a contour key point label; training a skeleton key point recognition model according to the first sample images, recognizing the skeleton key point in the second sample images according to the skeleton key point recognition model, and adding the skeleton key point pseudo-label to a recognized skeleton key point; and training a contour key point recognition model according to the second sample images, recognizing the contour key point in the first sample images according to the contour key point recognition model, and adding a contour key point pseudo-label to the recognized contour key point.

According to one or more embodiments of the present disclosure, training an image recognition model according to the sample image and a joint training loss function further includes: obtaining the skeleton key point recognition loss based on a predicted skeleton key point recognition result obtained by the joint model according to the sample images and the skeleton key point label corresponding to the sample images; obtaining the contour key point recognition loss based on a predicted contour key point recognition result obtained by the joint model according to the sample images and the contour key point label corresponding to the sample images; and performing weighted summation on the skeleton key point recognition loss and the contour key point recognition loss to obtain the joint training loss function.

According to one or more embodiments of the present disclosure, the method further includes: determining the weights of the skeleton key point recognition loss and the contour key point recognition loss in the joint training loss function according to numbers of the first sample images and the second sample images; wherein, in response that the first sample images are more than the second sample images, the weight of the skeleton key point recognition loss is less than that of the contour key point recognition loss; and in response that the first sample images are less than the second sample images, the weight of the skeleton key point recognition loss is greater than the weight of the contour key point recognition loss.

According to one or more embodiments of the present disclosure, the method includes: attenuating the weight of the contour key point recognition loss in response that the sample images are the first sample image added with the contour key point pseudo-label; or attenuating the weight of the skeleton key point recognition loss in response that the sample images are the second sample images added with the skeleton key point pseudo-label.

According to one or more embodiments of the present disclosure, the skeleton key point label marked in the sample images is represented by a sample skeleton key point heatmap, and the contour key point label is represented by a sample contour key point heatmap. The predicted skeleton key point recognition result is a predicted skeleton key point heatmap; and the predicted contour key point recognition result is a predicated contour key point heatmap.

According to one or more embodiments of the present disclosure, the method further includes: obtaining a mean-square error loss between the predicted human body key point heatmap and the sample human body key point heatmap; wherein the human body key points include at least one of the skeleton key point or the contour key point; obtaining a KL divergence loss in one dimension according to a coordinate sum of each human body key point in the predicted human body key point heatmap and a coordinate sum of each human body key point in the sample human body key point heatmap; wherein the one-dimensional direction includes an x-axis direction and a y-axis direction; and performing weighted summation on the mean-square error loss and the KL divergence loss in one dimension to obtain a human body key point recognition loss.

In a second aspect, according to one or more embodiments of the present disclosure, an image recognition apparatus is provided. The apparatus includes: an obtaining unit configured to obtain an image to be processed containing a human body; a processing unit configured to input the image to be processed into an image recognition model, wherein the image recognition model includes a feature extraction module, a skeleton key point decoding module and a contour key point decoding module; extract an image feature from the image to be processed by the feature extraction module; obtain a skeleton key point recognition result by the skeleton key point decoding module according to the image feature; and obtain a contour key point recognition result by the contour key point decoding module according to the image feature and the skeleton key point recognition result; and a key point determining unit configured to determine a skeleton key point and a contour key point in the image to be processed respectively according to the skeleton key point recognition result and the contour key point recognition result.

According to one or more embodiments of the present disclosure, when the skeleton key point decoding module obtains a skeleton key point recognition result according to the image feature, the processing unit is configured to: obtain a skeleton key point heatmap by the skeleton key point decoding module according to the image feature, and determine the skeleton key point heatmap as the skeleton key point recognition result; when the contour key point decoding module obtains a contour key point recognition result according to the image feature and the skeleton key point recognition result, including: fusing the image feature and the skeleton key point heatmap by the contour key point decoding module, obtaining the contour key point heatmap according to the fusion result, and determining the contour key point heatmap as the skeleton key point recognition result.

According to one or more embodiments of the present disclosure, the apparatus further includes: a training unit configured to: obtain a plurality of sample images containing a human body, wherein the sample images are marked with a skeleton key point label and a contour key point label; and train an image recognition model according to the sample images and a joint training loss function to obtain a trained image recognition model, wherein the joint training loss function includes a skeleton key point recognition loss and a contour key point recognition loss.

According to one or more embodiments of the present disclosure, when a plurality of sample images containing a human body are obtained, the training unit is configured to: obtain a plurality of first sample images and a plurality of second sample images, wherein the first sample images are marked with a skeleton key point label, and the second sample images are marked with a contour key point label; train a skeleton key point recognition model according to the first sample images, recognize the skeleton key point in the second sample image according to the skeleton key point recognition model, and add a skeleton key point pseudo-label to the recognized skeleton key point; train a contour key point recognition model according to the second sample images, recognize the contour key point in the first sample image according to the contour key point recognition model, and add a contour key point pseudo-label to the recognized contour key point.

According to one or more embodiments of the present disclosure, when the image recognition model is trained according to the sample images and a joint training loss function, the training unit is further configured to: obtain the skeleton key point recognition loss based on a predicted skeleton key point recognition result obtained by the joint model according to the sample images and the skeleton key point label corresponding to the sample images; obtain the contour key point recognition loss based on a predicted contour key point recognition result obtained by the joint model according to the sample images and the contour key point label corresponding to the sample images; and perform weighted summation on the skeleton key point recognition loss and the contour key point recognition loss to obtain the joint training loss function.

According to one or more embodiments of the present disclosure, the training unit is further configured to: determine the weights of the skeleton key point recognition loss and the contour key point recognition loss in the joint training loss function according to numbers of the first sample images and the second sample images; wherein, in response that the first sample images are more than the second sample images, the weight of the skeleton key point recognition loss is less than that of the contour key point recognition loss; and in response that the first sample images are less than the second sample images, the weight of the skeleton key point recognition loss is greater than the weight of the contour key point recognition loss.

According to one or more embodiments of the present disclosure, the training unit is further configured to: attenuate the weight of the contour key point recognition loss in response that the sample images are the first sample image added with the contour key point pseudo-label; or attenuate the weight of the skeleton key point recognition loss in response that the sample images are the second sample images added with the skeleton key point pseudo-label.

According to one or more embodiments of the present disclosure, the skeleton key point label marked in the sample images is represented by a sample skeleton key point heatmap, and the contour key point label is represented by a sample contour key point heatmap. The predicted skeleton key point recognition result is a predicted skeleton key point heatmap; and the predicted contour key point recognition result is a predicated contour key point heatmap.

According to one or more embodiments of the present disclosure, the training unit is further configured to: obtain a mean-square error loss between the predicted human body key point heatmap and the sample human body key point heatmap; wherein the human body key points include at least one of the skeleton key point or the contour key point; obtain a KL divergence loss in one dimension according to a coordinate sum of each human body key point in the predicted human body key point heatmap and a coordinate sum of each human body key point in the sample human body key point heatmap; wherein the one-dimensional direction includes an x-axis direction and a y-axis direction; and perform weighted summation on the mean-square error loss and the KL divergence loss in one dimension to obtain a human body key point recognition loss.

In a third aspect, according to one or more embodiments of the present disclosure, an electronic device is provided. The electronic device includes: at least one processor and a memory. The memory stores computer-executed instructions. The at least one processor executes the computer-executed instructions stored in the memory, so that the at least one processor performs the image recognition method as described above in the first aspect and various possible designs of the first aspect.

In a fourth aspect, according to one or more embodiments of the present disclosure, a computer-readable storage medium is provided. The computer-readable storage medium has computer-executable instructions stored thereon that, when executed by a processor, implement the image recognition method as described above in the first aspect and various possible designs of the first aspect.

In a fifth aspect, according to one or more embodiments of the present disclosure, a computer program product is provided. The computer program product includes computer-executable instructions that, when executed by a processor, implement the image recognition method as described above in the first aspect and various possible designs of the first aspect.

The above description is only an explanation of preferred embodiments of the present disclosure and the applied technical principles. Those skilled in the art should understand that the scope of disclosure involved in this disclosure is not limited to the technical solutions formed by the specific combination of the above technical features, and at the same time should also cover other technical solutions formed by arbitrarily combining the above-described technical features or equivalent features without departing from the above disclosed concept. For example, the above-described features and the technical features disclosed in the present disclosure (but not limited thereto) having similar functions are replaced with each other to form a technical solution.

In addition, although the operations are depicted in a specific order, this should not be understood as requiring these operations to be performed in the specific order shown or performed in a sequential order. Under certain circumstances, multitasking and parallel processing might be advantageous. Likewise, although several specific implementation details are contained in the above discussion, these should not be construed as limiting the scope of the present disclosure. Certain features that are described in the context of individual embodiments may also be implemented in combination in a single embodiment. On the contrary, various features described in the context of a single embodiment may also be implemented in multiple embodiments individually or in any suitable sub-combination.

Although the present subject matter has been described in language specific to structural features and/or methodological actions, it should be understood that the subject matter defined in the appended claims is not necessarily limited to the specific features or actions described above. On the contrary, the specific features and actions described above are only exemplary forms of implementing the claims.

1. An image identifying method, comprising:
obtaining an image to be processed containing a human body;
inputting the image to be processed into an image recognition model, wherein the image recognition model comprises a feature extraction module, a skeleton key point decoding module and a contour key point decoding module;
extracting an image feature from the image to be processed by the feature extraction module;
obtaining a skeleton key point recognition result by the skeleton key point decoding module according to the image feature;
obtaining a contour key point recognition result by the contour key point decoding module according to the image feature and the skeleton key point recognition result; and
determining a skeleton key point and a contour key point in the image to be processed respectively according to the skeleton key point recognition result and the contour key point recognition result.

2. The method according to claim 1, wherein obtaining a skeleton key point recognition result by the skeleton key point decoding module according to the image feature comprises:
obtaining a skeleton key point heatmap by the skeleton key point decoding module according to the image feature, and determining the skeleton key point heatmap as the skeleton key point recognition result; and
obtaining a contour key point recognition result by the contour key point decoding module according to the image feature and the skeleton key point recognition result comprises:
fusing the image feature and the skeleton key point heatmap by the contour key point decoding module, obtaining the contour key point heatmap according to the fusion result, and determining the contour key point heatmap as the skeleton key point recognition result.

3. The method according to claim 1, wherein the training process of the image recognition model comprises:
obtaining a plurality of sample images containing a human body, wherein the sample images are marked with a skeleton key point label and a contour key point label; and
training the image recognition model according to the sample images and a joint training loss function to obtain a trained image recognition model, wherein the joint training loss function comprises a skeleton key point recognition loss and a contour key point recognition loss.

4. The method according to claim 3, wherein obtaining a plurality of sample images containing a human body comprises:
obtaining a plurality of first sample images and a plurality of second sample images, wherein the first sample images are marked with a skeleton key point label, and the second sample images are marked with a contour key point label;
training a skeleton key point recognition model according to the first sample images, recognizing the skeleton key point in the second sample images according to the skeleton key point recognition model, and adding a skeleton key point pseudo-label to the recognized skeleton key point; and
training a contour key point recognition model according to the second sample images, recognizing the contour key point in the first sample images according to the contour key point recognition model, and adding a contour key point pseudo-label to the recognized contour key point.

5. The method according to claim 3, wherein training an image recognition model according to the sample image and a joint training loss function further comprises:
obtaining the skeleton key point recognition loss based on a predicted skeleton key point recognition result obtained by the joint model according to the sample images and the skeleton key point label corresponding to the sample images;
obtaining the contour key point recognition loss based on a predicted contour key point recognition result obtained by the joint model according to the sample images and the contour key point label corresponding to the sample images; and
performing weighted summation on the skeleton key point recognition loss and the contour key point recognition loss to obtain the joint training loss function.

6. The method according to claim 4, wherein the method further comprises:
determining the weights of the skeleton key point recognition loss and the contour key point recognition loss in the joint training loss function according to numbers of the first sample images and the second sample images;
wherein, in response that the first sample images are more than the second sample images, the weight of the skeleton key point recognition loss is less than that of the contour key point recognition loss; and in response that the first sample images are less than the second sample images, the weight of the skeleton key point recognition loss is greater than the weight of the contour key point recognition loss.

7. The method according to claim 4, wherein the method comprises:
attenuating the weight of the contour recognition loss in response that the sample images are the first sample images added with the contour pseudo-label; or
attenuating the weight of the skeleton recognition loss in response that the sample images are the second sample images added with the skeleton pseudo-label.

8. The method according to claim 5, wherein the skeleton key point label marked in the sample images is represented by a sample skeleton key point heatmap, and the contour key point label is represented by a sample contour key point heatmap; and
the predicted skeleton key point recognition result is a predicted skeleton key point heatmap; and the predicted contour key point recognition result is a predicated contour key point heatmap.

9. The method according to claim 8, further comprising:
obtaining a mean-square error loss between the predicted human body key point heatmap and the sample human body key point heatmap; wherein the human body key points comprise at least one of the skeleton key point or the contour key point;
obtaining a KL divergence loss in one dimension according to a coordinate sum of each human body key point in the predicted human body key point heatmap and a coordinate sum of each human body key point in the sample human body key point heatmap; wherein the one-dimensional direction comprises an x-axis direction and a y-axis direction; and
performing weighted summation on the mean-square error loss and the KL divergence loss in one dimension to obtain a human body key point recognition loss.

10. (canceled)

11. An electronic device, comprising: at least one processor and a memory;
wherein the memory stores computer-executed instructions; and
the at least one processor executes the computer-executed instructions stored in the memory, so that the at least one processor performs the method according to claim 1.

12. A non-transitory computer-readable storage medium, having computer-executable instructions stored thereon that, when executed by a processor, implement the method according to claim 1.

13. (canceled)

14. (canceled)

15. The method according to claim 2, wherein the training process of the image recognition model comprises:
obtaining a plurality of sample images containing a human body, wherein the sample images are marked with a skeleton key point label and a contour key point label; and
training the image recognition model according to the sample images and a joint training loss function to obtain a trained image recognition model, wherein the joint training loss function comprises a skeleton key point recognition loss and a contour key point recognition loss.

16. The method according to claim 15, wherein obtaining a plurality of sample images containing a human body comprises:
obtaining a plurality of first sample images and a plurality of second sample images, wherein the first sample images are marked with a skeleton key point label, and the second sample images are marked with a contour key point label;
training a skeleton key point recognition model according to the first sample images, recognizing the skeleton key point in the second sample images according to the skeleton key point recognition model, and adding a skeleton key point pseudo-label to the recognized skeleton key point; and
training a contour key point recognition model according to the second sample images, recognizing the contour key point in the first sample images according to the contour key point recognition model, and adding a contour key point pseudo-label to the recognized contour key point.

17. The method according to claim 16, wherein training an image recognition model according to the sample image and a joint training loss function further comprises:
obtaining the skeleton key point recognition loss based on a predicted skeleton key point recognition result obtained by the joint model according to the sample images and the skeleton key point label corresponding to the sample images;
obtaining the contour key point recognition loss based on a predicted contour key point recognition result obtained by the joint model according to the sample images and the contour key point label corresponding to the sample images; and
performing weighted summation on the skeleton key point recognition loss and the contour key point recognition loss to obtain the joint training loss function.

18. The method according to claim 16, wherein the method further comprises:
determining the weights of the skeleton key point recognition loss and the contour key point recognition loss in the joint training loss function according to numbers of the first sample images and the second sample images;
wherein, in response that the first sample images are more than the second sample images, the weight of the skeleton key point recognition loss is less than that of the contour key point recognition loss; and in response that the first sample images are less than the second sample images, the weight of the skeleton key point recognition loss is greater than the weight of the contour key point recognition loss.

19. The method according to claim 18, wherein the method further comprises:
attenuating the weight of the contour key point recognition loss in response that the sample images are the first sample images added with the contour key point pseudo-label; or
attenuating the weight of the skeleton key point recognition loss in response that the sample images are the second sample images added with the skeleton key point pseudo-label.

20. The method according to claim 17, wherein the skeleton key point label marked in the sample images is represented by a sample skeleton key point heatmap, and the contour key point label is represented by a sample contour key point heatmap; and
the predicted skeleton key point recognition result is a predicted skeleton key point heatmap; and the predicted contour key point recognition result is a predicated contour key point heatmap.

21. The method according to claim 20, further comprising:
obtaining a mean-square error loss between the predicted human body key point heatmap and the sample human body key point heatmap; wherein the human body key points comprise at least one of the skeleton key point or the contour key point;
obtaining a KL divergence loss in one dimension according to a coordinate sum of each human body key point in the predicted human body key point heatmap and a coordinate sum of each human body key point in the sample human body key point heatmap; wherein the one-dimensional direction comprises an x-axis direction and a y-axis direction; and
performing weighted summation on the mean-square error loss and the KL divergence loss in one dimension to obtain a human body key point recognition loss.

22. The method according to claim 15, wherein training an image recognition model according to the sample image and a joint training loss function further comprises:
obtaining the skeleton key point recognition loss based on a predicted skeleton key point recognition result obtained by the joint model according to the sample images and the skeleton key point label corresponding to the sample images;
obtaining the contour key point recognition loss based on a predicted contour key point recognition result obtained by the joint model according to the sample images and the contour key point label corresponding to the sample images; and
performing weighted summation on the skeleton key point recognition loss and the contour key point recognition loss to obtain the joint training loss function.

23. The method according to 16, wherein the method further comprises:
attenuating the weight of the contour key point recognition loss in response that the sample images are the first sample images added with the contour key point pseudo-label; or
attenuating the weight of the skeleton key point recognition loss in response that the sample images are the second sample images added with the skeleton key point pseudo-label.
